(19) United States
(12) Patent Application Publication
(10) Pub. No.: US 2007/0267922 A1
(43) Pub. Date: Nov. 22, 2007

(54) Actuator

(76) Inventor: Masahiko Uni, Ueda-shi (JP)

Correspondence Address: BIRCH STEWART KOLASCH & BIRCH, PO BOX 747, FALLS CHURCH, VA, 22040-0747, US

(21) Appl. No.: 11/667,479

(22) PCT Filed: Nov. 10, 2005
(86) PCT No.: PCT/JP05/20611

§ 371 Date: May 10, 2007

(51) Int. Cl. H02N 2/00

(52) U.S. Cl. 310/26; 310/27

(57) ABSTRACT

The present invention provides the actuator, which is capable of increasing a moving range of a movable element in which a specified output force can be gained by reducing variation of a thrust force caused by stroke amount. Either of peripheral surfaces (P1, P2) of a plunger (7), on which magnetic flux acting surfaces are formed by energization, and first and second yoke parts (5, 6) corresponding to the peripheral surfaces (P1, P2) of the plunger (7) have configurations capable of gradually varying magnetic resistance according to movement of the plunger (7).

### BACKGROUND OF THE INVENTION

The present invention relates to an actuator, e.g., linear solenoid.

### BACKGROUND TECHNOLOGY

Various types of actuators have been used for automatically controlling conventional industrial machines. For example, a linear solenoid is used as an electromagnetic component for converting electromagnetic energy into mechanical energy. A generic solenoid has a stator including an exciting coil and a movable iron core (plunger), which is provided to a center part of the stator and capable of moving to and away from a stator core. By energizing the exciting coil of the stator, a magnetic circuit is formed between a first and second yoke parts and the plunger, so that an attraction force acts on the plunger.

A generic structure of a conventional linear solenoid will be explained with reference to FIG. 4. Firstly, a stator 51 includes an exciting coil 53, which is wound on a bobbin 52, and first and second yoke parts 54 and 55, which cover the exciting coil 53. The first yoke part 54 is formed like a lid and covers the axial one end side of the exciting coil 53. The second yoke part 55 is formed into a cup shape and covers a body part of the exciting coil 53 from the other end side thereof. The first and second yoke parts 54 and 55 form a magnetic circuit on the stator 51 side when the exciting coil 53 is energized. A pipe (guide pipe) 56 made of a nonmagnetic material is fitted in an axial hole of the bobbin 52. A movable element (plunger) 57 is slidably fitted in an axial hole of the guide pipe 56. A connecting rod (not shown) is connected in an axial hole 58 of the plunger 57 so as to transmit a driving force for moving the plunger 57 in the axial direction.

A circular groove or a stepped surface (a groove 59 is employed in the shown example) is formed in a peripheral surface of at least one end side of the plunger 57, so that a magnetic flux acting surface is formed in the radial direction. Namely, the magnetic flux acting surfaces are respectively formed between the peripheral surfaces P1 and P2 of the plunger 57 and the corresponding surfaces Y1 and Y2 of the first and second yokes 54 and 55; thus, magnetic resistance between the opposing surfaces are low, so that a great output force (thrust force) can be gained in a controllable range.

### DISCLOSURE OF THE INVENTION

However, in the linear solenoid shown in FIG. 4, great attraction forces entire-circumferentially act between the peripheral surfaces P1 and P2 of the plunger 57 and the corresponding surfaces Y1 and Y2 of the first and second yoke parts 54 and 55.

According to the positional relationships between the plunger 57 and the first and second yoke parts 54 and 55, magnetic resistance is apt to be drastically varied, and the thrust force will be sharply increased when the exciting coil 53 is energized; therefore, a stroke controllable range, in which the stroke can be controlled with a constant thrust force, is limited, and controllability must be low (see a curve A shown in FIG. 3).

The present invention has been invented to solve the above described problems, and an object of the present invention is to provide an actuator, which is capable of increasing a moving range of a movable element in which a specified output force can be gained by reducing variation of a thrust force caused by stroke amount.

To achieve the object, the present invention has the following structures.

The actuator comprises: an exciting coil; a stator having a first yoke part, which is formed on the one end side of the exciting coil, and a second yoke part, which is formed on the other side of the exciting coil, so as to cover the exciting coil; and a movable element being provided in a center part of the exciting coil and capable of reciprocally moving in the axial direction, a magnetic circuit is formed between the first and second yoke parts and the movable element by energization, and a magnetic force acts on the movable element, and the actuator is characterized in that either of peripheral surfaces of the movable element, on which magnetic flux acting surfaces are formed by energization, and first and second yoke parts corresponding to the peripheral surfaces of the movable element have configurations capable of gradually varying magnetic resistance according to movement of the movable element.

In the actuator, the configurations may be capable of gradually varying distances between the movable element and the first and second yoke parts according to the axial movement of the movable element.

For example, at least one of the first yoke part and the second yoke part has a tapered surface or a stepped surface capable of gradually reducing the magnetic resistance according to the movement of the movable element toward the stator. Further, at least one of the peripheral surfaces of the movable element, which are corresponded to the first yoke part and the second yoke part, has a tapered surface or a stepped surface capable of gradually reducing the magnetic resistance according to the movement of the movable element toward the stator.

### EFFECTS OF THE INVENTION

In the above described actuator, either of the peripheral surfaces of the movable element, on which the magnetic flux acting surfaces are formed by energization, and the first and second yoke parts corresponding to the peripheral surfaces of the movable element have the configurations capable of gradually varying magnetic resistance according to the movement of the movable element; thus, the magnetic resistance is gradually reduced and an attraction force is increased with the movement of the movable element toward the stator, which is caused by energization, so that a specified thrust force can be gained within a long stroke range. Therefore, differences of thrust forces, which act on the movable element within an actual movable range, can be small, so that a stable output force can be gained and controllability can be improved.

### BRIEF DESCRIPTION OF THE DRAWINGS

FIG. 1 is a sectional view of a linear solenoid of a first embodiment;

FIG. 2 is a sectional view of a linear solenoid of a second embodiment;

FIG. 3 is a graph showing a relationship between displacement of linear solenoids and thrust forces;

FIG. 4 is a sectional view of the conventional linear solenoid.

### PREFERRED EMBODIMENTS OF THE INVENTION

Preferred embodiments of the actuator of the present invention will now be described with reference to the accompanying drawings. In the following embodiments, linear solenoids will be explained as the actuators.

### First Embodiment

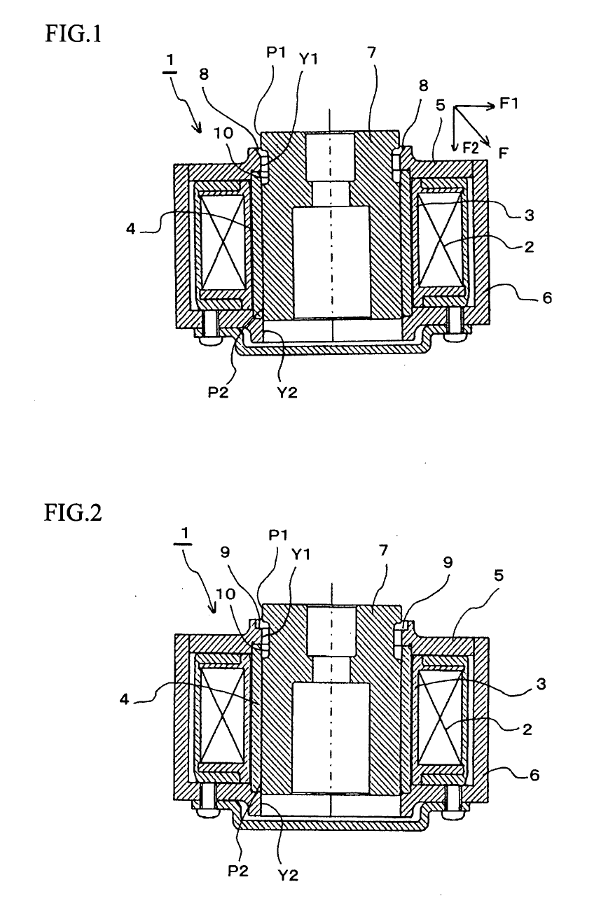

An outline of the linear solenoid will be explained with reference to FIG. 1.

Firstly, a stator 1 will be explained. An exciting coil 2 is wound on a bobbin 3. A pipe (guide pipe) 4 made of a nonmagnetic material is fitted in an axial hole of a core part of the bobbin 3. The exciting coil 2 is covered with a first yoke part 5, which is formed like a lid and provided on one end side, and a second yoke part 6, which is formed into a cup shape and covers form the other side. The first yoke part 5 and the second yoke part 6 are made of a magnetic material, and they form a magnetic flux path of the stator 1 when the exciting coil 2 is energized.

A movable element (plunger) 7 is guided by the guide pipe 4, which is provided to a center part of the exciting coil 2 (in the axial hole of the bobbin 3), and capable of reciprocally moving in the axial direction. Note that, the core part of the bobbin may be used for guiding the plunger 7 instead of the guide pipe 4. The plunger 7 is connected to a connecting rod (not shown). For example, in case of a pull type solenoid, the plunger 7 or the connecting rod may be biased to project from the stator 1 by, for example, a coil spring. By energizing the exciting coil 2, a magnetic circuit is formed between the first and second yoke parts 5 and 6 and the plunger 7, so that attraction forces act on the plunger 7.

In the solenoid of the present embodiment, a circular groove or a stepped surface is formed in a peripheral surface of at least one end side of the plunger 7 (a groove 10 is formed in the present embodiment), so that a magnetic flux acting surface is formed in the radial direction.

When the exciting coil 2 is energized, attraction forces F (horizontal component forces F1 and vertical component forces F2) entire-circumferentially act between a peripheral surface (the magnetic flux acting surface) P1 on the one end side of the plunger 7 and an corresponding surface Y1 of the first yoke part 5 and between a peripheral surface (the magnetic flux acting surface) P2 on the other end side of the plunger 7 and an corresponding surface Y2 of the second yoke part 6. The plunger 7 is attracted in the radial direction by a resultant force of the horizontal component forces F1 of the forces F and attracted, in the axial direction, toward the stator 1 by the vertical component forces F2 thereof.

In the solenoid of the present embodiment, either of the peripheral surfaces of the plunger 7, on which the magnetic flux acting surfaces are formed by energization, and the corresponding surfaces of the first and second yoke parts 5 and 6 have configurations capable of gradually varying magnetic resistance according to the movement of the plunger 7. For example, a tapered surface 8, which is capable of gradually reducing the magnetic resistance according to the movement of the plunger 7 toward the stator 1 (an inner diameter is gradually reduced toward axial outside), is formed in the corresponding surface Y1 of the first yoke part 5, on which the magnetic flux acting surface is formed. In other words, the tapered surface 8, which is capable of gradually reducing a distance to the first yoke part 5 according to the movement of the plunger 7 toward the stator 1, is formed in the corresponding surface Y1 of the first yoke part 5. The tapered surface 8 may be formed in the corresponding surface Y2 of the second yoke part 6, on which the magnetic flux acting surface is formed, or may be formed in the both of the corresponding surfaces Y1 and Y2.

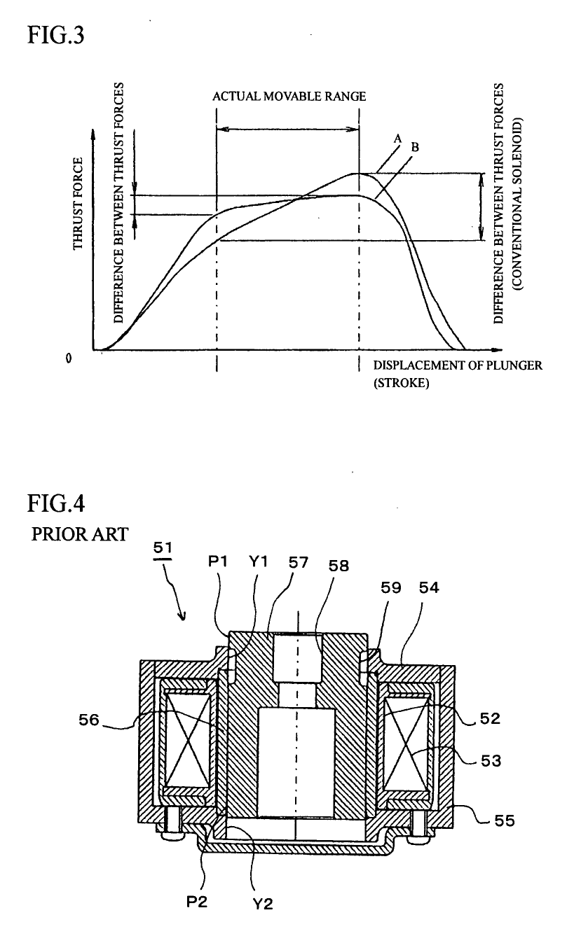

Energy of the linear solenoid is stored in a gap between the stator 1 and the movable element (the plunger) 7. Unlike the solenoid whose magnetic flux acting surfaces are formed in the axial direction, the solenoid shown in FIG. 3, whose magnetic flux acting surfaces are formed in the radial direction, is capable of increasing the thrust force in an actual movable range. However, the magnetic resistance is apt to be sharply varied according to the position of the plunger, so an actual movable range, in which a specified thrust force can be gained, is apt to be small (see a curve A shown in FIG. 3). On the other hand, by forming the tapered surface 8 in the surface Y1 of the first yoke part 5 corresponding to the peripheral surface P1 of the plunger 7, sharp variation of the magnetic resistance, which occurs according to positional relationships between the plunger 7 and the first and second yoke parts 5 and 6, especially which occurs when the magnetic flux acting surfaces of the plunger 7 and the first yoke part 5 mutually overlap, can be relieved. Therefore, as shown by a curve B shown in FIG. 3, the magnetic resistance is gradually reduced and the attraction force is increased with the movement of the plunger 7 toward the stator 1, which is caused by energization, so that the specified thrust force can be gained within the long stroke. Therefore, variation of the movable range of the plunger 7, which is caused by differences of the thrust forces, can be restrained, and the movable range of the plunger, in which the specified thrust force can be gained, can be increased.

### Second Embodiment

Next, another linear solenoid will be explained with reference to FIG. 2. The structure is similar to that shown in FIG. 1, so the same structural elements are assigned the same symbols and explanation will be omitted. The differences will be explained.

In the solenoid of the present embodiment, a stepped surface 9, which is capable of gradually reducing the magnetic resistance according to the movement of the plunger 7 toward the stator 1, is formed in the corresponding surface Y1 of the first yoke part 5, on which the magnetic flux acting surface is formed. In other words, the stepped surface 9, which is capable of gradually reducing the distance to the first yoke part 5 according to the movement of the plunger 7 toward the stator 1, is formed in the corresponding surface Y1 of the first yoke part 5. The stepped surface 9 is formed by forming a notch (step) in a part of the corresponding surface Y1 of the first yoke part 5 so as to relieve the sharp variation of the magnetic resistance, which occurs when the magnetic flux acting surfaces of the plunger 7 and the first yoke part 5 mutually overlap. Note that, the stepped surface 9 may be formed in the corresponding surface Y2 of the second yoke part 6, on which the magnetic flux acting surface is formed, or may be formed in the both of the surfaces Y1 and Y2. By forming the stepped surface or surfaces, the stroke range of the plunger, in which the specified thrust force can be gained, can be increased.

In the above described embodiments, the configurations of the yoke parts have been explained, but the same functions and effects can be gained by forming the tapered surface or the stepped surface, which is capable of gradually reducing the magnetic resistance according to the movement of the plunger toward the stator 1, in at least one of the peripheral surfaces of the plunger 7, which is corresponded to the first yoke part 5 or the second yoke part 6.

Note that, the shapes of the tapered surface and the stepped surface, which are formed in the magnetic flux acting surfaces, may be optionally designed, and the combinations of “the tapered surface and the stepped surface”, “the tapered surface and the tapered surface” and “the stepped surface and the stepper surface” may be optionally employed. The stepped surface may be constituted by concavities and convexities formed in the axial direction. Further, the tapered surface and the stepped surface may be formed in the peripheral surfaces and/or the first and second yoke parts 5 and 6. The linear solenoid may be a pull type or a push type, a permanent magnet may be included in the magnetic circuit, and the linear solenoid may be driven by a DC power source or an AC power source.

What is claimed is:

1. An actuator comprising: an exciting coil; a stator having a first yoke part, which is formed on the one end side of said exciting coil, and a second yoke part, which is formed on the other side of said exciting coil, so as to cover said exciting coil; and a movable element being provided in a center part of said exciting coil and capable of reciprocally moving in the axial direction, wherein a magnetic circuit is formed between the first and second yoke parts and said movable element by energization, and a magnetic force acts on said movable element,
said actuator being characterized in that either of peripheral surfaces of said movable element, on which magnetic flux acting surfaces are formed by energization, and first and second yoke parts corresponding to the peripheral surfaces of said movable element have configurations capable of gradually varying magnetic resistance according to movement of said movable element.

2. The actuator according to claim 1, wherein the configurations are capable of gradually varying distances between said movable element and the first and second yoke parts according to the axial movement of said movable element.

3. The actuator according to claim 1, wherein at least one of the first yoke part and the second yoke part has a tapered surface capable of gradually reducing the magnetic resistance according to the movement of said movable element toward said stator.

4. The actuator according to claim 1, wherein at least one of the first yoke part and the second yoke part has a stepped surface capable of gradually reducing the magnetic resistance according to the movement of said movable element toward said stator.

5. The actuator according to claim 1, wherein at least one of the peripheral surfaces of said movable element, which are corresponded to the first yoke part and the second yoke part, has a tapered surface capable of gradually reducing the magnetic resistance according to the movement of said movable element toward said stator.

6. The actuator according to claim 1, wherein at least one of the peripheral surfaces of said movable element, which are corresponded to the first yoke part and the second yoke part, has a stepped surface capable of gradually reducing the magnetic resistance according to the movement of said movable element toward said stator.
